(19) United States
(12) Patent Application Publication
(10) Pub. No.: US 2016/0093843 A1
(43) Pub. Date: Mar. 31, 2016

(54) SYSTEMS AND METHODS FOR A MODULAR BATTERY PACK

(71) Applicant: Powertree Services, Inc., San Francisco, CA (US)

(72) Inventors: Stacey Reineccius, San Francisco, CA (US); John C. Sellers, El Cerrito, CA (US); Franklin Gobar, San Rafael, CA (US)

(21) Appl. No.: 14/498,532

(22) Filed: Sep. 26, 2014

(51) Int. Cl. H01M 2/10; H01M 10/052; H01M 10/42; H01M 2/34; H01M 10/48

(52) U.S. Cl. CPC H01M 2/1016; H01M 2/34; H01M 10/488; H01M 10/65; H01M 10/425; H01M 2/1022; H01M 2/1072; H01M 10/052; H01M 2010/4271; H01M 2010/4278; H01M 2200/103; H01M 2220/20; H01M 2220/30

(57) ABSTRACT

A modular battery pack system includes a chassis for selective insertion and removal of a plurality of battery cells. The chassis includes a plurality of battery cell compartments, a backplane assembly, and one or more mechanical actuators. The plurality of battery cell compartments are each configured to receive a battery cell. The backplane assembly is configured to provide electrical connection from one or more batteries in the plurality of battery cell compartments to a load. The one or more mechanical actuators are configured to selectively establish electrical communication between the backplane assembly and the one or more batteries when the battery cell is within one of the plurality of battery compartments.

### TECHNICAL FIELD

The present disclosure relates to battery pack systems and more particularly relates to systems and methods for a modular battery pack.

### BRIEF DESCRIPTION OF THE DRAWINGS

FIG. 1 is a schematic block diagram illustrating a modular battery pack consistent with embodiments disclosed herein.

FIG. 2 is a schematic diagram illustrating a system for managing a plurality of battery packs consistent with embodiments disclosed herein.

FIG. 3 is a perspective view of a modular battery pack consistent with embodiments disclosed herein.

FIG. 4 is a perspective view of the modular battery pack of FIG. 3 with a door removed consistent with the embodiments disclosed herein.

FIG. 5 is a front view of some interior components of the modular battery pack of FIG. 3 consistent with the embodiments disclosed herein.

FIG. 6 is a close-up perspective view of a backplane assembly consistent with embodiments disclosed herein

FIG. 7 is a front cutaway view of battery cells in engaged and disengaged positions consistent with embodiments disclosed herein.

FIG. 8 is an enlarged perspective view of a mechanical actuator consistent with embodiments disclosed herein.

FIG. 9 is a perspective view of a battery cell consistent with embodiments disclosed herein.

FIG. 10 is a perspective view of a battery cell compartment sleeve consistent with embodiments disclosed herein.

FIG. 11 is a perspective view illustrating the battery cell of FIG. 9 inserted into the battery cell compartment of FIG. 10 consistent with embodiments disclosed herein.

FIG. 12 is a schematic flow chart diagram illustrating a method for assembly or installation of a modular battery pack consistent with embodiments disclosed herein.

### DETAILED DESCRIPTION OF PREFERRED EMBODIMENTS

Electrical energy storage systems are widely used in a variety of technological areas, including for computing devices, power tools, energy storage, back-up power storage, electric vehicles, and the like. As energy needs expand, the need for inexpensive and high-capacity energy storage is also increasing. One example of a system for electrical energy storage includes a battery pack that includes a plurality of battery cells that are combined into a single battery pack to provide electrical energy for a load.

However, Applicants have recognized various aspects of existing high-energy battery packs that present challenges and disadvantages. For example, high-energy battery packs are currently assembled in a very inflexible fashion. Often, these battery packs are made up of a number of cells in series which may or may not have a battery management capability. These battery packs typically have to be moved, installed, or otherwise handled with live battery voltages and are physically bulky and very heavy.

Typically, battery cells are mechanically interconnected such that the battery cells cannot be removed independently of each other. For example, the battery packs are often assembled in series with heavy copper bussing between the terminals of cells. Bolts, welding, or other connection methods may be used which require special skills or knowledge, especially in relation to the live voltages involved. Once assembled, these battery packs can be very heavy to lift or install. For example, a typical Lithium 16 cell 180 amp-hour (Ah) pack can easily weigh more than 300 pounds when fully assembled. Once connected, higher voltages exist in the battery pack and, if errors occur or a cell goes bad, labor costs in assembling battery packs or systems can be very high. Additionally, shipping and transporting can be a significant challenge, not only because of the weight, but because of the potentially hazardous voltages. In fact, the weight and hazard concerns can prevent an assembled battery pack from being shipped by certain forms of transport, such as courier service or air transport. Another consideration is that the heavy weight and hazard of working on batteries with high system voltage require specially trained personnel and more expensive handling equipment. A combination of being difficult to ship and difficult to assemble can lead to significant costs, as expensive shipping or expensive on-site labor may be needed. Furthermore, these dangers and challenges also lead to higher potential insurance costs, which can be significant business costs.

Further concerns include the costs and inventory of cells that must be purchased in advance for initial pack assembly. Advance purchase is required because the battery cells are needed to even begin assembly of the pack. The purchase is also often long in advance of final electrical department inspection and signoff at the site of installation. The early purchasing of cells and other components for a battery pack can significantly increase the costs of the pack and any system using the pack, due to costs of capital and associated shipping and finance fees, which can add as much as 5% to 10% to the overall battery pack cost. Furthermore, building the packs with battery cells reduces the ability to achieve economies of scale, since each cell must be extensively handled and no pack can be ready for delivery and use until cells are wired in and the pack is assembled.

Furthermore, existing battery packs have very little flexibility in sales and design. For example, battery packs must be produced with a very precise knowledge of the battery cells' capacity in advance. As a further example, battery pack designs tend to lock in to single vendors because the packs are typically mechanically specific and pre-assembled. For this reason, the end customer or contractor has little flexibility in selecting alternate suppliers or achieving cost benefits of competitive supplier bidding. These factors increase lead times, lower volume production capabilities, and lower design flexibility.

After installation, system expansion is constrained and expensive due to sophisticated battery management systems and the requirements for multiple pack assemblies to be connected in series or parallel. For example, Lithium packs require sophisticated battery management systems to prevent cell damage during overcharge or undercharge situations. Often, these systems are self-contained within each pack with a combination of a controller and individual cell monitoring boards. Expansion of the energy or power capacity of a pack requires the combination in series or parallel of multiple pack assemblies. This multi-pack assembly today typically involves redundant electronics duplicating the same function in each pack, adding to cost.

In light of the foregoing, Applicants propose systems and methods for a modular battery pack and a modular battery pack chassis which overcome one or more of the above disadvantages. In one embodiment, a modular battery pack system includes a chassis for selective insertion and removal of a plurality of battery cells. The chassis includes a plurality of battery cell compartments, a backplane assembly, and one or more mechanical actuators. The plurality of battery cell compartments are each configured to receive a battery cell. The backplane assembly is configured to provide electrical connection from one or more batteries in the plurality of battery cell compartments to a load. The one or more mechanical actuators are configured to selectively establish electrical communication between the backplane assembly and one or more batteries when a battery cell is within one of the plurality of battery compartments while keeping the technician fully insulated from the cell and potentially hazardous voltages.

In one embodiment, a battery pack may include solid state (e.g., printed on a printed circuit board) cell interconnection. In one embodiment, a battery pack may use mechanical blade terminals and sockets to provide high-current battery interconnections. In one embodiment, the battery pack may include cell movers (cell actuators or translators) to allow cell-by-cell handling with minimum force and increased safety by avoiding installer contact with battery cells. In one embodiment, cell holders (e.g., sleeves) are used as heat sinks. Some embodiments enable safe removal and replacement of high-power cells even when the system is operating. In one embodiment, front panel cell balancing indicators and cell/pack status indicators are used to visually indicate a status to an operator. In one embodiment, battery packs are individually identifiable (via addressing), enabling enhanced control, graceful failure, and increased usable energy from a system.

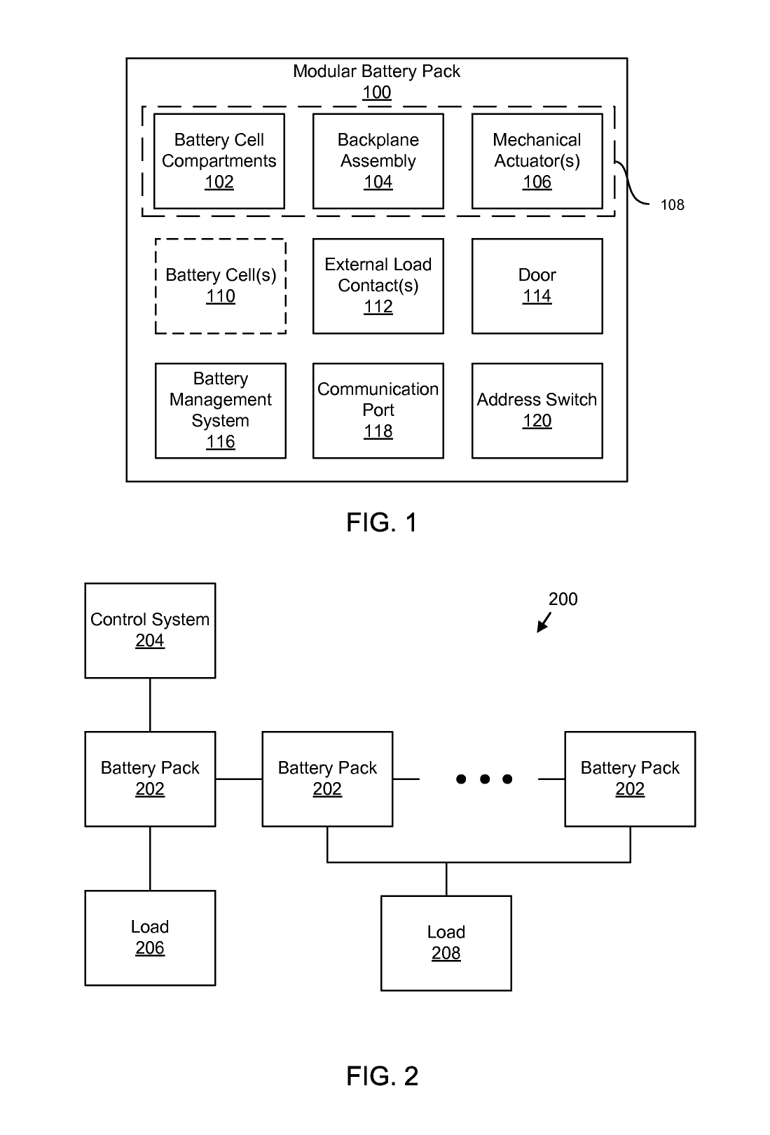

Turning to the figures, FIG. 1 is a schematic block diagram illustrating one embodiment of a modular battery pack 100. The modular battery pack 100 includes a plurality of battery cell compartments 102, a backplane assembly 104, and one or more mechanical actuators 106 as part of a chassis 108. The modular battery pack 100 may or may not include a plurality of battery cells 110. The modular battery pack 100 also includes one or more external load contacts 112, a door 114, a battery management system 116, a communication port 118, and an address switch 120. Note that the components 102-120 of the modular battery pack 100 are given by way of illustration only and not all components 102-120 are included in all embodiments. In fact, various embodiments may include any one or any combination of two or more of the components 102-120.

The battery cell compartments 102 are each configured to selectively receive a battery cell 110. In one embodiment, a battery cell compartment 102 has a size and dimensions corresponding to a battery cell 110. In one embodiment, each battery cell compartment 102 is separate to allow for independent removal and insertion of a corresponding battery cell 110. For example, the battery cell compartment 102 may allow a battery cell 110 to be inserted into or removed from the compartment. In one embodiment, the battery cell compartment 102 may include a sleeve into which the battery cell 110 can be selectively inserted or removed. In one embodiment, the battery cell compartments 102 are separate and independent such that a battery cell 110 can be removed or inserted independently of a battery cell 110 corresponding to another battery cell compartment 102, without disassembly of a chassis 108.

In one embodiment, the battery cell compartment 102 may slide relative to the chassis 108 or the backplane assembly 104. For example, the plurality of battery cell compartments 102 may be slidably mounted in relation to the backplane assembly 104. In one embodiment, the battery cell compartment 102 can be selectively placed in an engaged position in which a battery cell 110 in the battery cell compartment 102 is in electrical communication with the backplane assembly 104, or in a disengaged position in which the battery cell 110 is electrically isolated from the backplane assembly 104.

In one embodiment, when the battery cell compartment 102 is in the engaged position, the battery cell 110 is secured within the battery cell compartment 102. In one embodiment, when the battery cell compartment 102 is in the disengaged position, the battery cell 110 can be removed or inserted into the battery cell compartment 102. In one embodiment, each battery cell compartment 102 can be placed in an engaged or disengaged position independently of one or more of the other battery cell compartments 102. In one embodiment, a battery cell 110 may be removed or inserted into the battery cell compartment 102 along a first axis while the battery cell compartment 102 is slidable along a second axis, wherein the first axis is substantially transverse to the second axis. For example, an angle between the first axis and second axis may be approximately 90 degrees. For example, the battery cell 110 may be inserted into the battery cell compartment 102 in a first direction and then the battery cell compartment 102 may be actuated in a transverse direction towards the engaged position to place the battery cell 110 in electrical communication with the backplane assembly 104. As another example, the battery cell compartment 102 may be actuated in a first direction towards the disengaged position and then the battery cell 110 may be removed from the battery cell compartment 102 in a direction transverse to the first direction.

In one embodiment, a heat sink may be positioned in or near the battery cell compartment 102 to dissipate heat generated by a battery cell 110. For example, the battery cell compartment 102 may include a thermally conductive sleeve (such as a metallic sleeve) that is thermally coupled to the heat sink. Heat generated by a battery cell 110 within the sleeve may be conducted through the sleeve to the heat sink for dissipation. Fans within the modular battery pack 100 may draw heat from the heat sink to remove heat from the battery cell 110.

The backplane assembly 104 is configured to provide electrical connection from one or more battery cells 110 in the plurality of battery cell compartments 102 to a load. In one embodiment, the backplane assembly 104 comprises a rigid support structure to physically and electrically couple with the battery cells 110. In one embodiment, the rigid support structure includes a printed circuit board (PCB). The PCB may include one or more electrical contact surfaces, vias, traces, layers, or the like.

The backplane assembly 104 may include one or more electrical contacts corresponding to each battery cell compartment 102. For example, the electrical contacts may be mounted or attached to the rigid support structure at locations corresponding to each battery cell 110. The electrical contacts may include a slot or protrusion corresponding to a protrusion or slot, respectively, of a battery cell 110. For example, the slot and protrusion may have a corresponding shape to electrically couple to the battery cell 110 to provide electrical energy from the battery cell 110 to a load.

In one embodiment, the backplane assembly 104 includes one or more electrical interconnections connecting the one or more electrical contacts (e.g., slots or protrusions of the backplane assembly 104) to an outlet (such as the external load contacts 112) of the modular battery pack 100. The electrical interconnections may include electrical traces printed on a PCB, bus bars, or other electrical conductors. In one embodiment, the electrical interconnections include bus bars attached to the electrical contacts. The bus bars may provide a rigid support structure as well as an electrical conductive path. The bus bars may provide for series, parallel, or a combination of series and parallel interconnection of battery cells 110. In one embodiment, a battery cell 110 is removable without disrupting operation of the modular battery pack 100. For example, the battery cell 110 may be removed even while the modular battery pack 100 is providing current to a load, even if the overall capacity of the modular battery pack 100 is reduced. In one embodiment, the backplane assembly 104 includes a double-sided backplane where some battery cells 110 may be connected on a first side and other battery cells 110 may be connected on a second side opposite the first side.

In one embodiment, the backplane assembly 104 includes one or more electrical traces to connect a battery management system 116 with a terminal of each battery cell 110. For example, the battery management system 116 may be able to independently determine a status of each battery cell 110 with battery cell compartments 102. In one embodiment, the backplane assembly 104 includes a fuse configured to stop the flow of electric current from the modular battery system. For example, the fuse may blow or melt in order to create an open circuit if an excessive current is detected.

In one embodiment, the backplane assembly 104 is separate from the battery cell compartments 102, mechanical actuators 106, or other portions of the modular battery pack 100 to allow the backplane assembly 104 to be preassembled separately from other components. For example, the backplane assembly 104 may be assembled using bolts, screws, or the like to reduce chances of error in assembly. For example, a backplane assembly 104 with electrical contacts, PBC, and bus bars may be less subject to error, and allow for less skilled assembly, than wires or welded components. In one embodiment, the backplane assembly 104 can be quickly assembled by hand or machine.

A mechanical actuator 106 is configured to selectively establish electrical communication between the backplane assembly 104 and one or more battery cells 110 within one of the plurality of battery cell compartments 102. In one embodiment, the mechanical actuator 106 selectively actuates a battery cell compartment 102 towards or away from the backplane assembly 104. For example, the mechanical actuator 106 may actuate the battery cell compartments 102 in a first direction towards an engaged position or in a second direction towards a disengaged position. A battery cell 110 within the battery cell compartment 102 may then be physically placed into or removed from electrical communication with the backplane assembly 104. In one embodiment, each battery cell compartment 102 may have a corresponding mechanical actuator 106 to allow each battery cell compartment 102 to be independently placed in the engaged or disengaged position. The mechanical actuator 106 may include any type of mechanism that may be used to place the backplane assembly 104 in electrical communication with a battery cell 110. For example, the mechanical actuator 106 may include one or more of: a lever; a handle; a threaded fastener that can be tightened to move the backplane assembly 104, the battery cell compartment 102, or a battery cell 110 within the battery cell compartment 102; a locking mechanism; or the like. The mechanical actuator 106 may move the battery cell compartment 102, a battery cell 110 within the battery cell compartment 102, the backplane assembly 104, or an electrical contact that electrically connects a battery cell 110 to the backplane assembly 104.

In one embodiment, the modular battery pack 100 includes a chassis 108 that provides a support structure for one or more components 102-106 and 110-120 of the modular battery pack 100. For example, the chassis 108 may include a frame that provides structural support for the battery cell compartments 102, the backplane assembly 104, and/or the mechanical actuators 106. In one embodiment, the battery cell compartments 102, backplane assembly 104, and/or mechanical actuators 106 form at least a portion of the chassis 108 and provide at least a portion of the structural support for the chassis 108. In one embodiment, the chassis 108 allows for selective insertion and removal of a plurality of battery cells 110. In one embodiment, when the chassis 108 is in an assembled state, a battery cell 110 is selectively removable and insertable from a corresponding battery cell compartment 102 independently of other battery cells 110 and without disassembly of the chassis 108. For example, the chassis 108 can remain fully assembled even when all battery cells 110 have been removed.

A chassis 108 that remains assembled without any battery cells 110 installed allows the chassis 108 (and other parts of a battery pack) to be assembled, tested, shipped, installed, or the like, without any battery cells 110. Being able to perform these actions without the battery cells 110 can provide a large number of benefits. First, shipping costs can be significantly reduced, as the chassis 108 is much lighter without the battery cells 110, and the options for shipping methods are much broader as the dangers caused by high voltages or mechanically fixed volumes of lithium cells are non-existent. Second, the chassis 108 may be assembled and tested at a factory, rather than on-site, which can lead to significant savings while avoiding high shipping costs. Third, the modular battery pack 100 can be tested for proper assembly, interconnections, and installation without live voltages, leading to reduced hazards and increased ability to test the modular battery pack 100. Fourth, if an error is found after assembly, the chassis 108 can be disassembled and reassembled without the hazard of voltages in the system, which leads to reduced dangers, reduced required skill levels, and potentially reduced insurance costs. Fifth, battery cells 110 can be ordered and installed as needed, or just-in-time for operation, reducing the cost of upfront capital, financing, or degradation of unused battery cell capacity. These advantages are given by way of example only and may not be present in all embodiments. Further advantages may also be achieved as disclosed herein and as will be recognized by one of skill in the art.

The battery cells 110 may include any type of battery cell or electrical storage device known in the art. According to one embodiment, the battery cells 110 include one or more of a flow battery, a fuel cell, a lead-acid battery, a Lithium based battery, a Nickel based battery, or any other type of rechargeable or non-rechargeable battery known in the art or which may be developed. In one embodiment, the battery cells 110 may include a battery cell 110 for each battery cell compartment 102 of the modular battery pack 100. In one embodiment, the battery cells 110 are each independently and selectively removable from the modular battery pack 100. In one embodiment, a capacity of the modular battery pack 100 may be adjusted by inserting or removing a battery cell 110 from a corresponding battery cell compartment 102. In one embodiment, the modular battery pack 100, with a battery cell 110 in each battery cell compartment 102 has an electrical energy storage capacity of at least 100 Ah, at least 180 Ah, or more. In one embodiment, a battery cell 110 is removable without disrupting operation of the battery pack.

The external load contacts 112 may include any type of electrical connection interface or port known in the art. A load may be coupled to the external load contacts 112. The external load contacts 112 may be electrically coupled to the backplane assembly 104 to provide electrical energy from any installed battery cells 110 to an attached load.

The door 114 may allow access to an interior of the modular battery pack 100. For example, the modular battery pack 100 may include one or more panels enclosing the battery cell compartments 102, the backplane assembly 104, the mechanical actuators 106, the chassis 108, and/or other components of the modular battery pack 100. In one embodiment, the door 114 allows access to the battery cell compartments 102 for selective insertion or removal of the battery cells 110. In one embodiment, the door 114 includes a panel mounted on hinges, fasteners, or the like. In one embodiment, the door 114 is configured to be placed in an open configuration for access to the plurality of battery cell compartments 102 for selective insertion or removal of the battery cells 110, or in a closed configuration to secure components 102-112, 116-120 of the modular battery pack 100 within an interior of the modular battery pack 100. In one embodiment, the modular battery pack 100 may include a switch or other detection mechanism to detect when the door 114 is in the open configuration. In one embodiment, the switch may turn off power flow from the modular battery pack 100 when the door 114 is in the open configuration. For example, the switch may break a circuit to reduce the amount of electrical voltage built up from any battery cells 110 in the modular battery pack 100 or to maintain high voltages within the backplane assembly 104.

The battery management system 116 is configured to manage operation of the modular battery pack 100. The battery management system 116 may control operation of the modular battery pack 100 to limit over-charging or over-discharging of the one or more battery cells 110. For example, the battery management system 116 may stop electrical current flow into or out of the battery cells 110 to prevent overheating or damage to the battery cells 110 from over-charge or over-discharge. In one embodiment, the battery management system 116 may control operation of one or more fans configured to induce airflow for cooling the interior of the modular battery pack 100.

In one embodiment, the battery management system 116 is configured to control operation of the modular battery pack 100 based on signals received from an external electronic device. For example, the battery management system 116 may receive signals from a control system or from another battery pack. The control system may include a computing system, such as a server or workstation computer that is in communication with the battery management system 116 via a network and/or the communication port 118. In one embodiment, the battery management system 116 controls a switch between the one or more battery cells 110 and the external load contacts 112. The battery management system 116 may selectively stop or start flow of electrical energy using the switch. In one embodiment, the battery management system 116 may selectively stop or start flow of electrical energy based on signals received via the communication port 118. In one embodiment, the battery management system 116 may selectively start electrical flow by gradually ramping up power (current and/or voltage) from the battery cells 110 and/or to the external load contacts 112 to reduce sparking or other hazards (e.g., soft start). In one embodiment, the battery management system 116 controls one or more indicator lights to visually indicate a status of the modular battery pack 100.

The address switch 120 may include a switch used to designate an address for the modular battery pack 100. For example, if a plurality of battery packs (e.g., via a daisy chain) are connected to the modular battery pack 100, each pack may have a different address. The address may be specified by manipulating the switch to indicate the address of the modular battery pack 100. In one embodiment, the address switch 120 includes a dual in-line package (DIP) switch with a plurality of switches to select the address or may include a rotating selector switch. In one embodiment, the battery management system 116 may detect the address of the modular battery pack 100 based on a current state of the address switch 120. The battery management system 116 may use the address to determine which signals are meant for the modular battery pack 100 or for a different battery pack. In one embodiment, the battery management system 116 includes an addressing component configured to determine an address of the system, and the battery management system 116 is addressable based on the address. One of skill in the art will recognize that the address can be determined electronically or automatically (e.g., based on order of hook-up) and thus a physical address switch 120 may not be present in all embodiments. For example, a circuit or a computer-readable medium may store or otherwise indicate the current address of the modular battery pack 100.

FIG. 2 is a schematic block diagram illustrating a system 200 for managing a plurality of battery packs 202. The system 200 includes a plurality of battery packs 202, and a control system 204. The battery packs 202 are connected to loads 206, 208 to provide electrical energy as a primary energy source, backup energy source, or the like. The battery packs 202 may be combined to support a single load (e.g., in series or in parallel) or may be connected to separate loads. Each of the battery packs 202 may include a modular battery pack, such as the modular battery pack 100 of FIG. 1. The control system 204 may include any type computing device or battery management system. For example, the control system 204 may include a server, a desktop computer, or any other type of computing device that is running software or includes circuitry to manage operation of the battery packs 202.

One of the battery packs 202 is shown connected to the control system 204. For example, the battery pack 202 may be connected to the control system 204 via a communication port 118. In one embodiment, the battery pack 202 connected to the control system 204 may be a primary battery pack while battery packs 202 that are further down the chain are secondary battery packs. The primary battery pack 202 may receive instructions from the control system 204 to control operation of the battery pack 202 and any battery packs 202 connected in the depicted battery pack chain. In one embodiment, each of the battery packs 202 is addressable so that a specific battery pack 202 may be taken offline without affecting operation of the other battery packs. In one embodiment, the battery management system 116 discussed in FIG. 1 allows the battery packs 202 to communicate with the control system 204 and/or other battery packs 202. For example, the battery pack 202 connected to the control system 204 may forward signals received from the control system 204 to the other battery packs 202.

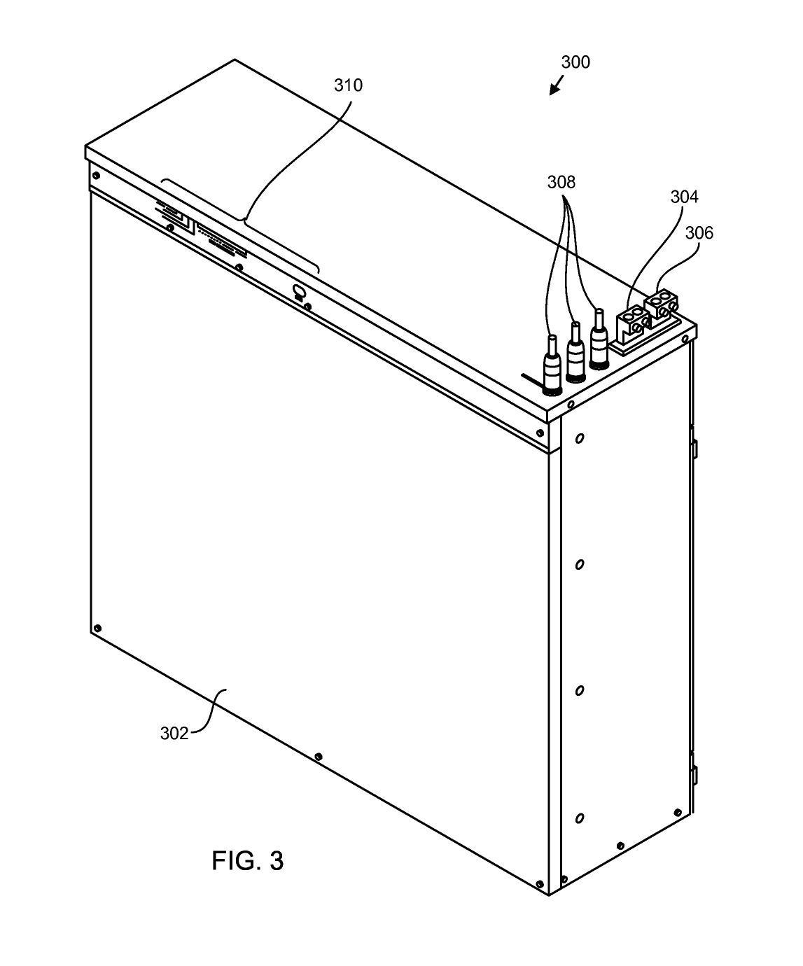

Turning now to FIGS. 3-11, further example embodiments of a modular battery pack are disclosed. The embodiments of FIGS. 3-11 may include any of the variations discussed in relation to FIGS. 1 and 2. Furthermore, any of the variations discussed in relation to FIGS. 3-11 may be applied to the embodiments of FIGS. 1 and 2.

FIG. 3 is as perspective view of a modular battery pack 300. The modular battery pack 300 is shown with panels enclosing an interior of the modular battery pack 300 to protect the interior components and for safety. The modular battery pack 300 may also include one or more mounting features to mount the modular battery pack 300 to a wall, rack, or other location. The modular battery pack 300 includes a door 302 which may be placed in an open configuration (e.g., by removal of one or more screws) to access an interior of the modular battery pack 300. For example, the door 302 may be opened or removed to test the modular battery pack 300, insert battery cells, remove battery cells, or gain access to other components of the modular battery pack 300. The modular battery pack 300 includes power connectors to connect the modular battery pack 300 to ground and/or to a load. In one embodiment, the power connectors include a negative power connector 304 and a positive (hot) power connector 306. Note that the positive power connector 306 may be located towards a rear of the modular battery pack 300 for safety, to reduce likelihood of inadvertent contact. The power connectors 304, 306 may connect to cables or loads using standard attachment methods such as screws and bolts, sockets, adaptors, or other types of connectors. The power connectors 304, 306 may be electrically connected to battery cells within the modular battery pack 300 via one or more bus bars and/or a backplane assembly.

The modular battery pack 300 also includes communication connectors 308 to function as one or more communication ports. The communication connectors 308 may allow for connection to an external control system, a backup controller for the battery pack, and/or a downstream or upstream battery pack. For example, a first connector of the communication connectors 308 may be connected to a control system if the modular battery pack 300 is a primary battery pack or to an upstream battery pack if the modular battery pack 300 is a secondary battery pack. A second connector may be used to connect to a backup battery pack, such as a battery pack that is used to provide power in case of the modular battery pack 300 being offline. A third connector may be used to provide downstream communication with a secondary battery pack. The communication connectors 308 and an internal battery management system may allow for management of a large number of battery packs with only one battery pack being connected to an external control system.

The modular battery pack 300 includes an indicator panel 310 to indicate a status of the modular battery pack 300 or systems of the modular battery pack 300. The indicator panel 310 may include a pack status indicator to indicate whether the modular battery pack 300 is currently providing power to the power connectors 304, 306 or if the modular battery pack 300 is available to provide power. The indicator panel 310 may include a backup status indicator to indicate whether a backup battery pack is available in case of failure of the modular battery pack 300. The indicator panel 310 may include a contactor failure indicator to indicate whether the power connectors 304, 306 are electrically connected to a load or if some other electrical interconnection in the modular battery pack 300 has failed. The indicator panel 310 may include a fuse state indicator that indicates whether a fuse or breaker has been tripped, placing the modular battery pack 300 offline. For example, if a fuse is blown due to a short or other error, the fuse state indicator may light to indicate to an operator that the fuse has blown. The indicator panel 310 may include a battery management system indicator to indicate activity of an interior battery management system. For example, the battery management system indicator may light when a signal is being received or sent by the battery management system. In one embodiment, the indicator panel 310 includes one or more cell balancing indicators to indicate balancing of cells within the modular battery pack 300. For example, the cell balancing indicators may indicate relative undercharge, overcharge, or other conditions of battery cells within compartments of the modular battery pack 300.

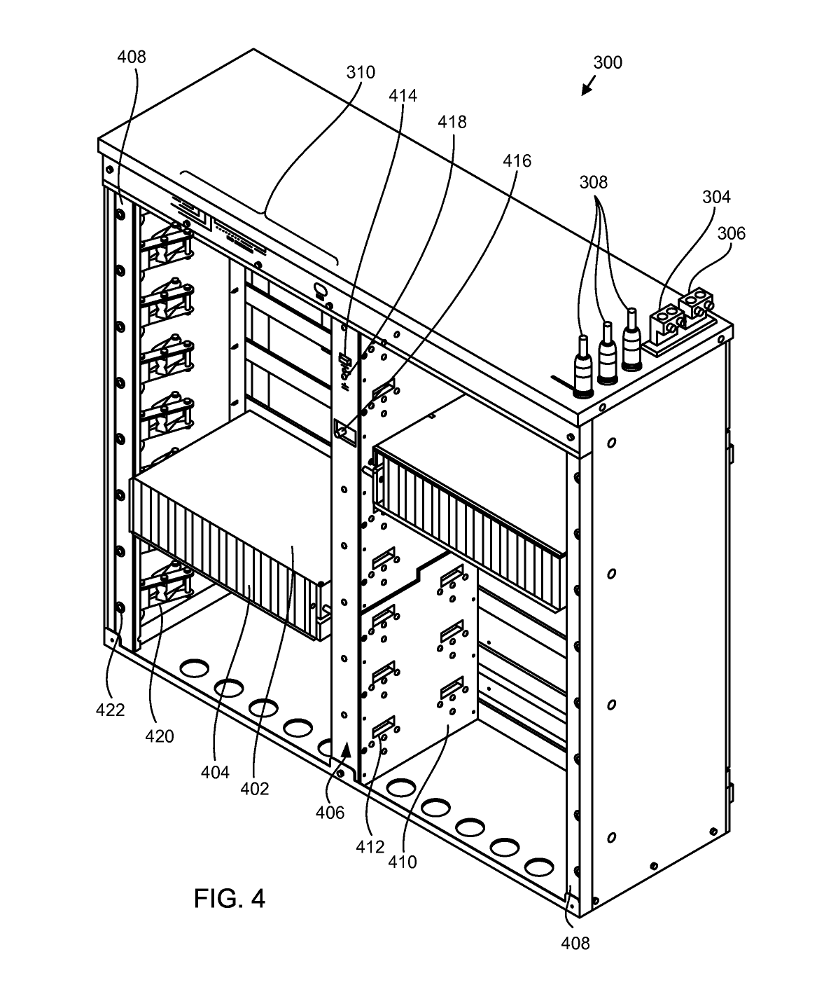

FIG. 4 is a perspective view of the modular battery pack 300 of FIG. 1 with the door 302 removed to show one embodiment of an interior of the modular battery pack 300. With the door 302 removed a plurality of battery cell compartments are accessible for inserting or removing battery cells. In the embodiment of FIG. 4, the battery cell compartments include a sleeve 402 or holder into which a battery cell 404 can be placed. Only two sleeves 402 and battery cells 404 are shown to avoid obscuring other portions of the interior of the modular battery pack 300. However, up to 16 sleeves 402 may be present in the embodiment of FIG. 4, providing battery cell compartments for up to 16 battery cells 404. Generally, the other sleeves 402 are mounted within the interior even when a corresponding battery cell 404 is not inserted. For example, the sleeves 402 may be permanently mounted within the modular battery pack 300 when a chassis is assembled. The sleeves 402 are organized in two vertical columns with a double-sided backplane assembly 406 disposed between them and cell translator linkage racks 408 located on the sides.

The backplane assembly 406 is configured to selectively electrically couple with battery cells 404 within the sleeves 402. The backplane assembly 406 includes bus bars or other conductors providing interconnection between the battery cells 404 to provide electricity to the power connectors 304, 306. In one embodiment, the backplane assembly 406 provides for wire-free serial, or parallel, build-up of voltage while allowing for selective and independent removal or insertion of the battery cells 404. For example, the backplane assembly 406 may be assembled using components that hold their shape and that are bolted or screwed together, instead of using wires which can bend and be deformed and lead to confusion during an assembly process. The backplane assembly 406 also provides mechanical support to the modular battery pack 300 and may be a part of a chassis of the modular battery pack 300.

The backplane assembly 406 includes a PCB 410 with slots 412 for receiving corresponding blades or terminals of the battery cells 404. The PCB 410 may include an insulating material with conductive traces, pads, or vias formed thereon. In one embodiment, the PCB 410 includes pads and holes to which sockets can be attached using screws or bolds. In one embodiment, conductive traces may run along a surface or interior layer of the PCB 410 to provide electrical connection to a battery management system. The battery management system may monitor the battery cells 404 for cell balancing, cell health, or other purposes. Another PCB 410 with slots 412 facing towards the other column of sleeves 402 is not visible in the view of FIG. 4.

The backplane assembly 406 also includes a configuration port 414 for programming a battery management system or other component of the modular battery pack 300. For example, the modular battery pack 300 may be programmed to operate according to a series configuration where battery cells 404 are connected in series, or according to a parallel configuration where the battery cells 404 are connected in parallel. The configuration port 414, in one embodiment, includes a serial communications port. The configuration port 414 may be used to test, debug, or otherwise examine operation of the modular battery pack 300.

The backplane assembly 406 includes a door configuration switch 416 that detects whether the door 302 is in an open configuration (e.g., the door 302 is removed). In one embodiment, the door configuration switch 416 is configured to automatically disable current flow from the modular battery pack 300 when the door 302 is removed. For example, the door configuration switch 416 may include a spring-loaded switch that is biased towards a position that disables current flow.

The backplane assembly 406 includes a manual override switch 418 that overrides the door configuration switch 416. For example, the manual override switch 418 may be used to test normal operation of the modular battery pack 300 when the door 302 is removed. In one embodiment, an indicator indicates whether the manual override switch 418 is active to indicate to a user that there are high voltages present in the opened modular battery pack 300.

The cell translator linkage racks 408 are located on opposite sides of the modular battery pack 300 and on opposite sides of the battery cells 404 in relation to the backplane assembly 406. The cell translator linkage racks 408 include a vertical panel with a plurality of mechanical actuators 420 for each battery cell compartment (e.g., each sleeve 402). The mechanical actuators 420 may be attached to each sleeve 402. In one embodiment, the mechanical actuators 420 can be independently operated to move a corresponding battery cell 404 and/or sleeve 402 towards or away from the backplane assembly 406. For example, the mechanical actuators 420 may be used to push a battery cell 404 towards the backplane assembly 406 such that terminals of the battery cell 404 are pressed into the slots 412 of the backplane assembly 406. Similarly, the mechanical actuators 420 may be used to pull the battery cell 404 away from the backplane assembly 406 such that the terminals of the battery cell 404 are removed from the slots 412 and electrically isolated from the backplane assembly 406. In one embodiment, each mechanical actuator 420 can be independently actuated by rotating a bolt 422 for the corresponding mechanical actuator 420. In one embodiment, the mechanical actuators 420 and/or bolt 422 are electrically isolated from the battery cell 404 so that the position of the sleeves 402 and battery cells 404 can be safely adjusted by a technician.

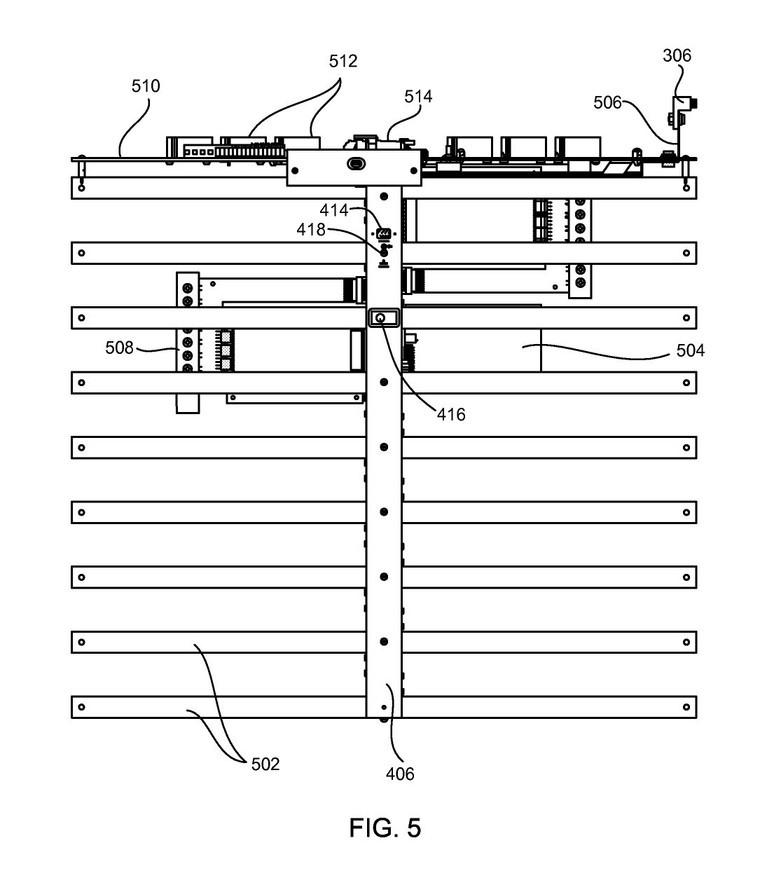

FIG. 5 is a front view of the modular battery pack 300 of FIG. 4 with all sleeves 402, battery cells 404, cell translator linkage racks 408, and external paneling removed. The backplane assembly 406 is shown with cell ties 502. In one embodiment, the cell ties 502 provide structure to a chassis of a modular battery pack 300. In one embodiment, the cell ties 502 act as rails on which the sleeves 402 slide. The backplane assembly 406 is shown connected to a battery management control unit 504, which may include at least a portion of a battery management system. The battery management control unit 504 may be connected to the backplane assembly 406 via a port that connects to one or more traces in the PCBs 410 of the backplane assembly 406. For example, the battery management control unit 504 may be able to monitor operation of battery cells 404 and the modular battery pack 300. The backplane assembly 406 is connected to bus bars 506 which provide an electrically conductive pathway to the power connectors 304, 306. A bleed resistor and heat sink 508 are also attached to the backplane assembly 406.

An insulating shelf 510 supports a plurality of fans 512 for inducing airflow through the modular battery pack 300. Other components, including thermistors (heat-sensitive resistors) may also be included to determine a rate of air flow to be induced by the fans 512. A pack address switch 514 may be used to set an address for the modular battery pack.

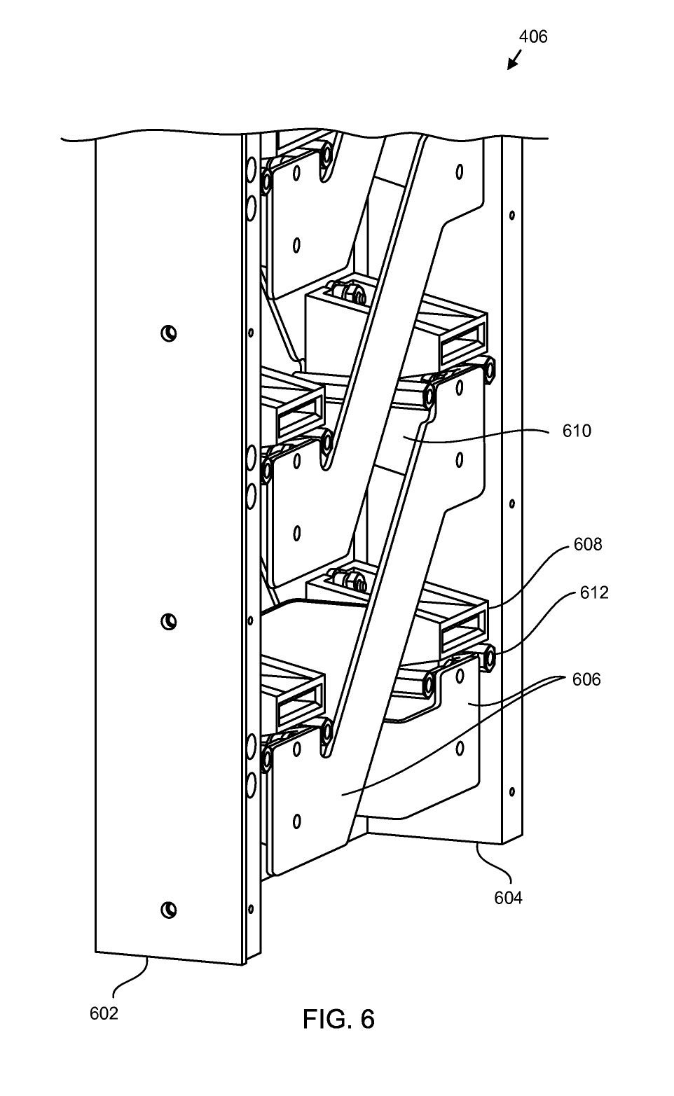

FIG. 6 is a perspective close-up view of a portion of the backplane assembly 406 with a PCB 410 removed. The backplane assembly 406 includes a front PCB support panel 602 and a back PCB support panel 604. A right PCB 410 is removed to show internal bus bars 606 and connecting sockets 608, 610 to connect corresponding battery cells 404 to an output of the modular battery pack 300. The sockets 608, 610 include a right facing socket 608 to receive a terminal from a battery cell 404 located to the right of the backplane assembly 406, and a left facing socket 610 to receive a terminal from a battery cell 404 located to the left of the backplane assembly 406, as pictured. The sockets 608, 610 may include electrical contacts to couple with terminals extending into the sockets 608, 610. In one embodiment, the sockets 608, 610 include two or more interior conductive surfaces (e.g., opposing surfaces) to provide a large contact area with a battery cell 404 terminal. A plurality of standoffs 612 with threaded interiors may be used to couple left and right PCBs 410, sockets 608, 610, and bus bars 606 together. In one embodiment, the parts of the backplane assembly 406 are clamped via screws in the standoffs 612. In one embodiment, the complete backplane assembly 406 of PCBs 410, PCB support panels 602, 604, bus bars 606, sockets 608, 610, and standoffs 612 provides electrical paths and physical rigidity and strength to hold the cells and form a portion of a chassis of a modular battery pack 300.

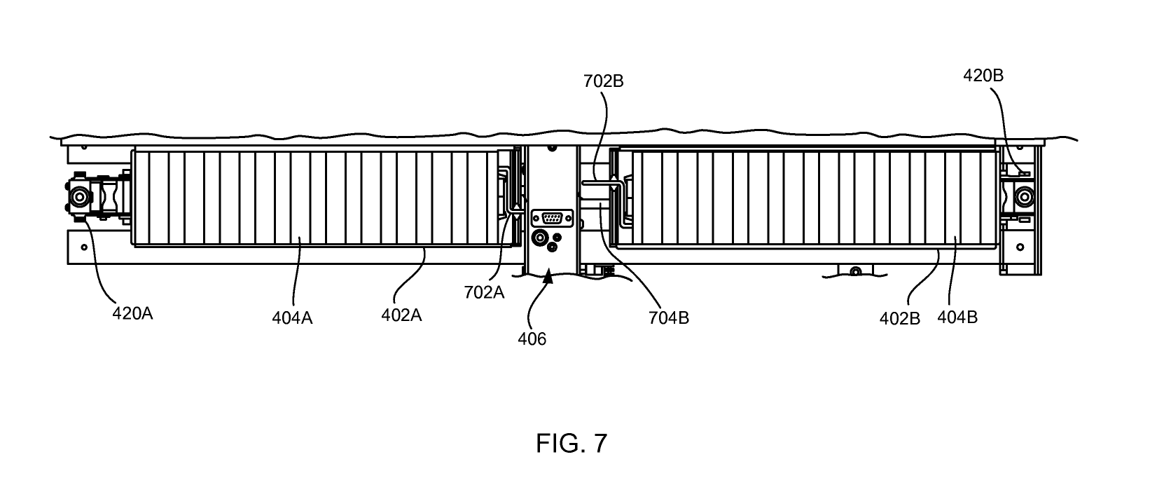

FIG. 7 is a front cutaway view of battery cells 404 in engaged and disengaged positions. More specifically, a first battery cell 404A is shown within a first sleeve 402A. A first mechanical actuator 420A is shown in an extended position such that the first sleeve 402A is in an engaged position. The first battery cell 404A is shown with a terminal 702A extending into a slot (not shown) in the backplane assembly 406. Furthermore, a second battery cell 404B is shown within a second sleeve 402B. A second mechanical actuator 420B is shown in a retracted position such that the second sleeve 402B is in a disengaged position. The second battery cell 404B is shown with a terminal 702B which is removed from a slot (not shown) in the backplane assembly 406. A cell alignment post 704B is shown extending into the backplane assembly 406 to maintain alignment of the second sleeve 402B with the backplane assembly 406. A cell alignment post for the first sleeve 402A is not visible. Thus, in FIG. 7, the first battery cell 404A is in electrical communication with the backplane assembly 406 while the second battery cell 404B is electrically isolated from the backplane assembly 406.

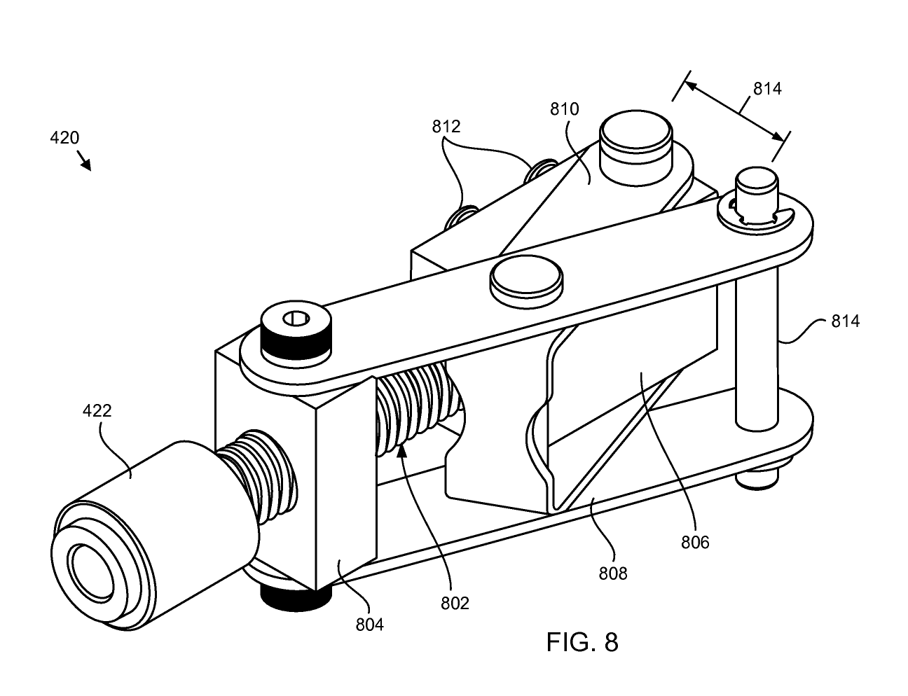

FIG. 8 is an enlarged perspective view of a mechanical actuator 420. The mechanical actuator 420 includes a bolt 422 with threads 802 corresponding to a threaded nut 804. The bolt 422 is anchored in a free spinning base 806. A first arm 808 is pivotably connected to the threaded nut 804, and a second arm 810 is pivotably connected to the base 806 and pivotably connected the second arm 810. A pin 814 on an end of the first arm 808 may be used to connect to a sleeve 402 of a battery cell compartment. The base 806 may be anchored to a panel such as a cell translator linkage rack 408 using screws 812.

The bolt 422 may be rotated to adjust a distance between the threaded nut 804 and the base 806 and thereby adjust lateral dimension 814 of the mechanical actuator 420. For example, a user may rotate the bolt 422 by hand or using a tool, such a screwdriver, hex wrench, or the like. In one embodiment, a power driver such as a drill or electric screwdriver may be used to rotate the bolt 422. When mounted within the modular battery pack 300 of FIGS. 3-4, the mechanical actuator 420 may be used to selectively place a corresponding battery cell compartment in an engaged or disengaged position. For example, as the lateral dimension 814 is increased, a sleeve 402 may be forced towards a backplane assembly 406. On the other hand, as the lateral dimension 814 is decreased, the sleeve 402 may be pulled away from the backplane assembly 406.

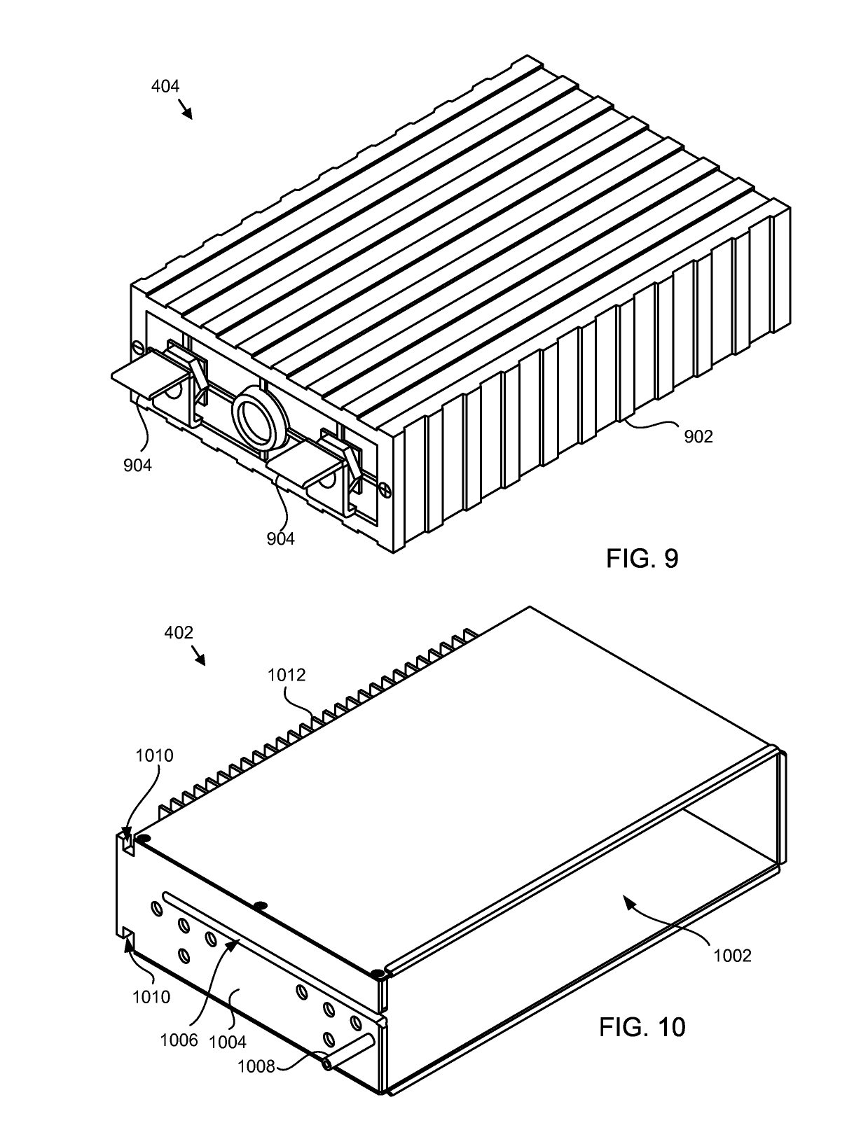

FIG. 9 is a perspective view of a battery cell 404, according to one embodiment. The battery cell 404 may include any type of battery cell, such as a Lithium based battery cell, a Nickel based battery cell, or any other type of battery or electrical storage device known in the art. In one embodiment, the battery cell 404 includes a plurality of batteries enclosed in a housing 902. Electrical output and a voltage may be created at terminals 904. The terminals 904 include blade-shaped terminals with an elongated flat shape attached and oriented such that when inserted into the cell holder 402 it is mechanically certain that the correct positive and negative polarity is maintained.

FIG. 10 is a perspective view of a battery cell compartment sleeve 402, according to one embodiment. The sleeve 402 forms a recess 1002 for receiving a battery cell 404, such as the battery cell 404 of FIG. 9. In one embodiment, the recess 1002 has a shape and size to receive a corresponding battery cell 404. The sleeve 402 has a front panel 1004 with a channel 1006 allowing terminals 904 of a battery cell 404 to extend through the front panel 1004. The channel 1006 allows the battery cell 404 to be slid into the recess 1002 with the terminals 904 extending through the sleeve 402 and selectively extending into sockets in the backplane assembly 406. An alignment post 1008 may be positioned to align with and extend into a hole in the backplane assembly 406 to keep the sleeve 402 aligned with a corresponding socket 608, 610 on the backplane assembly 406. Slots 1010 near a rear of the sleeve 402 may allow the sleeve 402 to be slidably mounted on the cell ties 502 illustrated in FIG. 5. A heat sink 1012 is coupled to the sleeve 402 to draw heat from the sleeve 402 to the heat sink 1012 to cool the battery cell compartment and a battery cell 404. In one embodiment, a portion or a majority of the sleeve 402 is formed of metal or other thermally conductive material to draw heat from a battery cell 404 into the sleeve 402 and onto the heat sink 1012. In one embodiment, the sleeve 402 includes a connector (not shown) to couple or attach the sleeve 402 to a mechanical actuator 420.

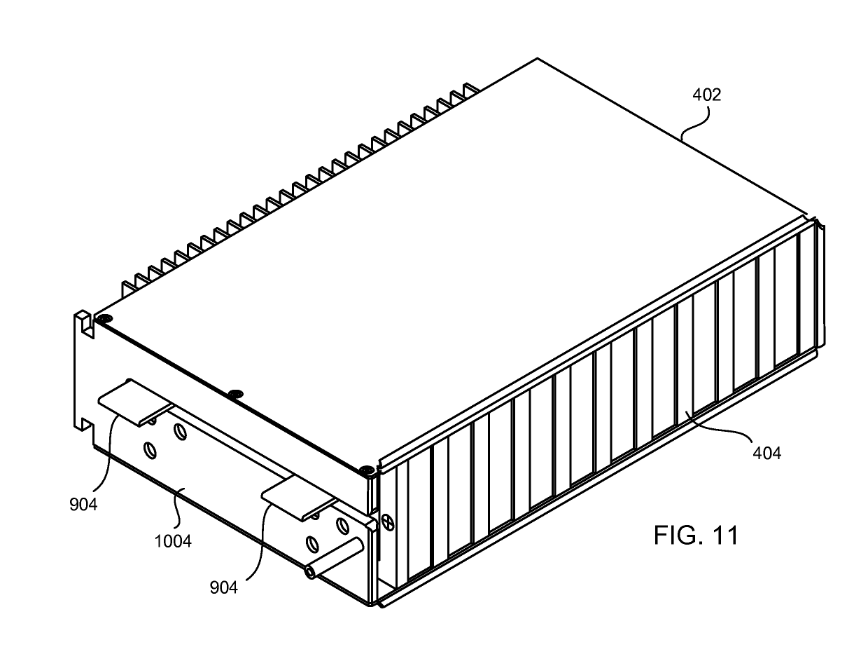

FIG. 11 is a perspective view of the battery cell 404 inserted into the sleeve 402. The terminals 904 are shown extending through the front panel 1004 such that they can selectively extend into a socket of a backplane assembly 406. The terminals 904 with blade shapes, and corresponding sockets, can provide for significant contact surface area between the battery cell 404 and the socket while allowing the blade to be slid in and out of the sleeve 402.

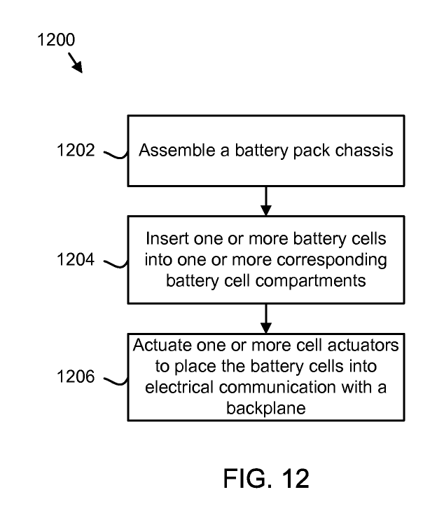

FIG. 12 is a schematic flow chart diagram illustrating a method 1200 for assembly of a modular battery pack. For example, the method 1200 may be performed using a modular battery pack such as the modular battery pack 100 of FIG. 1 or the modular battery pack 300 of FIG. 3.

The method 1200 begins and a user and/or machine assembles 1202 a battery pack chassis, such as the battery pack chassis 108 of FIG. 1 or a chassis of the modular battery pack 300 of FIG. 3. In one embodiment, assembling 1202 includes assembling a chassis that includes a plurality of battery cell compartments, a backplane assembly, and one or more mechanical actuators. In one embodiment, the plurality of battery cell compartments are each configured to receive a battery cell. In one embodiment, the backplane assembly is configured to provide electrical connection from one or more battery cells in the plurality of battery cell compartments to a load. The mechanical actuators are configured to selectively establish electrical communication between the backplane assembly and the one or more battery cells when the one or more battery cells are within one or more of the plurality of battery compartments. In one embodiment, the assembled chassis does not include any battery cells. For example, the battery cells may not be needed for the structure of the chassis or for structural support of the chassis.

The method 1200 further includes inserting 1204 the one or more battery cells into one or more corresponding battery cell compartments. For example, a battery cell may be slid into a sleeve of a battery cell compartment. The method 1200 further includes actuating 1206 one or more cell actuators configured to slide the one or more compartments towards the backplane assembly to establish electrical communication between the battery cells and the backplane assembly. In one embodiment, the battery cells are inserted into the battery cell compartments in a first direction and the mechanical actuator moves the battery cell compartments in a second direction substantially transverse to the first direction.

In one embodiment, the method 1200 further includes testing the assembled battery pack enclosure prior to inserting 1204 the battery cells. For example, the battery cells may be inserted 1204 in response to the assembled battery pack chassis passing testing. In one embodiment, the method 1200 further includes shipping the battery pack chassis without the one or more battery cells. In one embodiment, the method 1200 further includes installing the battery pack chassis prior to inserting the one or more battery cells.

One embodiment disclosed herein includes pre-printed and pre-assembled wiring or electrical interconnection of battery cells, reducing labor time and wiring errors. On embodiment includes an integrated programmable battery management system allowing use of a single primary (master) controller shared across multiple packs via daisy chaining controls. The battery management system is usable either in parallel packs or in serial packs for higher voltages. Some of these features are enabled through the use of a PCB and a serialized battery management system, which may lower system level costs. The battery management system allows multi-pack control from a central point and enables “graceful failure” without disrupting operations. For example, use of a cell translators assembly, cell holders, blades on cells, and sockets pre-mounted to a PCB enables an operator to add or remove individual cells with ease and without requiring rewiring or rework of other cells or packs in a system.

Some embodiments reduce risk of contact with high-voltage or high-power components when handling either the modular battery pack or individual battery cells. For example, the battery pack may be assembled and tested without battery cells. Furthermore, battery cells can be delivered separately and at the most cost-effective time in a project. These aspects allow for a reduction in capital cost of a project by allowing cells to be added after all electrical inspections and installation are complete. Furthermore, battery packs may be shipped after assembly and without battery cells, which leads to reduced shipping weight, shipping hazards, and insurance costs.

The ability to remove the battery cells without disassembly of the chassis in which a battery pack may be mounted allows the battery pack to be completely pre-wired into place and inspected on-site without having battery cells in the pack. Furthermore, embodiments include: soft starts to reduce sparking in contactors; individual battery pack isolation to allow servicing while operations can continue; fusing integrated into a battery pack; visual safety indicators using the indicator panel; and allowance for backup power and for monitoring to be drawn from a backup battery pack to ensure operations even during grid or external power supply outages.

Various aspects of certain embodiments may be implemented using hardware, software, firmware, or a combination thereof. As used herein, a software component may include any type of computer instruction or computer-executable code located within or on a non-transitory computer-readable storage medium. A software component may, for instance, comprise one or more physical or logical blocks of computer instructions, which may be organized as a routine, program, object, component, data structure, etc., that performs one or more tasks or implements particular abstract data types.

In certain embodiments, a particular software component may comprise disparate instructions stored in different locations of a computer-readable storage medium, which together implement the described functionality of the component. Indeed, a component may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, a digital-video disk, a magnetic tape, a Bernoulli drive, a magnetic disk, a punch card, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing the processes, apparatuses, and system described herein. Accordingly, the present embodiments are to be considered illustrative and not restrictive, and the invention is not to be limited to the details given herein, but may be modified within the scope and equivalents of the appended claims.

As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus.

It will be obvious to those having skill in the art that many changes may be made to the details of the above-described embodiments without departing from the underlying principles of the invention. The scope of the present invention should, therefore, be determined only by the following claims.

1. A modular battery pack system comprising:
a chassis for selective insertion and removal of a plurality of battery cells, the chassis comprising,
a plurality of battery cell compartments each configured to receive a battery cell,
a backplane assembly configured to provide electrical connection from one or more batteries in the plurality of battery cell compartments to a load, and
one or more mechanical actuators configured to selectively establish electrical communication between the backplane assembly and the one or more batteries when the battery cell is within one of the plurality of battery compartments.

2. The modular battery pack system of claim 1, wherein the plurality of battery cell compartments are slidably mounted in relation to the backplane assembly, and wherein the one or more mechanical actuators are configured to selectively actuate the battery cell compartments in a first direction towards an engaged position and in a second direction towards a disengaged position, wherein a battery cell in a compartment is in electrical communication with the backplane assembly when a corresponding compartment is in an engaged positioned and wherein the battery cell in the compartment is electrically isolated from the backplane assembly when the corresponding compartment is in a disengaged position.

3. The modular battery pack system of claim 2, wherein the plurality of battery cell compartments are slidable along a first axis and wherein the plurality of battery cells compartments are configured to selectively receive or release a corresponding battery cell along a second axis, wherein the first axis is substantially transverse to the second axis.

4. The modular battery pack system of claim 2, wherein the plurality of battery cell compartments are configured to release a corresponding battery cell when the plurality of battery cell compartments are in the disengaged position.

5. The modular battery pack system of claim 1, wherein the one or more mechanical actuators comprise a mechanical actuator for each of the plurality of battery cell compartments.

6. The modular battery pack system of claim 1, wherein when the modular battery pack chassis is an assembled state, the battery cell is selectively removable and insertable from a corresponding battery cell compartment independently of other battery cells and without disassembly of the chassis.

7. The modular battery pack system of claim 1, wherein the backplane assembly comprises:
a rigid support structure;
one or more electrical contacts corresponding to each compartment mounted on the rigid support structure; and
one or more electrical interconnections connecting the one or more electrical contacts to an outlet of the modular battery pack system.

8. The modular battery pack system of claim 7, wherein the one or more electrical contacts comprise one or more of:
a socket for receiving and electrically coupling to a protrusion of a battery cell; and
a protrusion for extending into and electrically coupling to a socket on the battery cell.

9. The modular battery pack system of claim 7, wherein the rigid support structure comprises a printed circuit board (PCB).

10. The modular battery pack system of claim 1, further comprising one or more panels enclosing one or more of the plurality of battery cell compartments, the backplane assembly, and the one or more mechanical actuators.

11. The modular battery pack system of claim 10, wherein the one or more panels comprise a door for selective access to an interior of the modular battery pack system, wherein the door is configured to be placed in an open configuration for access to the plurality of battery cell compartments for selective insertion or removal of the battery cell.

12. The modular battery pack system of claim 10, further comprising a switch configured to turn off power flow from the modular battery pack when the door is in the open configuration.

13. The modular battery pack system of claim 1, further comprising one or more external electrical contacts configured to provide electrical power from the modular battery pack system to a load.

14. The modular battery pack system of claim 1, further comprising one or more fans configured to induce airflow through an interior of the modular battery pack system.

15. The modular battery pack system of claim 1, wherein one or more of the plurality of battery cell compartments comprise a sleeve configured to selectively receive the battery cell, wherein the sleeve is in thermal communication with a heat sink.

16. The modular battery pack system of claim 1, further comprising a battery cell corresponding to each of the plurality of battery cell compartments, wherein the modular battery pack system comprises an electrical energy storage of at least 100 amp-hours (Ah).

17. A modular battery pack system comprising:
a plurality of battery cell compartments each configured to receive a corresponding battery cell, wherein each of the plurality of battery cell compartments is configured for selective receipt and removal of the corresponding battery cell independently of a battery cell corresponding to another battery cell compartment of the plurality of battery cell compartments, without disassembly of a chassis of the modular battery pack system;
one or more electrical contacts configured to provide electrical energy to a load external to the modular battery pack system;
a backplane assembly configured to provide electrical connection from one or more battery cells in the plurality of battery cell compartments to the one or more electrical contacts; and
a battery management system configured to control operation of the modular battery pack system based on signals received from an external electronic device.

18. The modular battery pack system of claim 17, wherein the external electronic device comprises a battery management system of another module battery pack.

19. The modular battery pack system of claim 17, wherein the external electronic device comprises a remote computing system.

20. The modular battery pack system of claim 17, further comprising an addressing component configured to determine an address of the modular battery pack system, wherein the battery management system is addressable based on the address.

21. The modular battery pack system of claim 17, wherein the battery management system is configured to selectively start electrical flow by gradually ramping up power.

22. The modular battery pack system of claim 17, wherein the modular battery pack system further comprises one or more indicator lights and wherein the battery management system is configured to indicate a status of the modular battery pack system using the indicator lights.

23. The modular battery pack system of claim 17, further comprising a communication port to communicate with the external electronic device.

24. The modular battery pack system of claim 17, further comprising a fuse configured to stop the flow of electric current from the modular battery system.

25. The modular battery pack system of claim 17, further comprising a housing enclosing one or more of the battery cell compartments, the backplane assembly, and the battery management system.

26. A method comprising:
assembling a battery pack chassis, the battery pack chassis comprising:
a plurality of battery cell compartments each configured to receive a battery cell,
a backplane assembly configured to provide electrical connection from one or more battery cells in the plurality of battery cell compartments to a load, and
one or more mechanical actuators configured to selectively establish electrical communication between the backplane assembly and the one or more battery cells when the one or more battery cells are within one or more of the plurality of battery compartments;
inserting the one or more battery cells into one or more corresponding battery cell compartments; and
actuating one or more cell actuators configured to slide the one or more compartments towards the backplane assembly to establish electrical communication between the battery cells and the backplane assembly.

27. The method of claim 26, further comprising testing the assembled battery pack chassis prior to inserting the battery cells, wherein inserting the battery cell comprises inserting the battery cell in response to testing the assembled battery pack enclosure.

28. The method of claim 26, further comprising shipping the battery pack chassis without the one or more battery cells.

29. The method of claim 26, further comprising installing the battery pack chassis prior to inserting the one or more battery cells.
